(19) United States
(12) Patent Application Publication
(10) Pub. No.: US 2019/0125087 A1
(43) Pub. Date: May 2, 2019

(54) MUSIC LISTENING APPARATUS

(71) Applicant: Sunfield Technique Japan Ltd., Chiba (JP)

(72) Inventor: Hiroshi AIZAWA, Chiba (JP)

(21) Appl. No.: 16/092,224

(22) PCT Filed: Apr. 14, 2017
(86) PCT No.: PCT/JP2017/015247

§ 371 Date: Oct. 9, 2018

(30) Foreign Application Priority Data
Apr. 18, 2016 (JP) 2016-082931

(51) Int. Cl. A47C 7/72; H04R 5/02; H04R 1/02; H04S 7/00; A47C 1/034

(52) U.S. Cl. CPC A47C 7/727; H04R 5/02; A47C 1/0342; H04S 7/302; H04R 1/025

(57) ABSTRACT

An apparatus includes a seat for a listener to sit on, a sound-insulating housing body integral with the seat to surround the listener on the seat, and a leg supporting the housing body. The housing body includes a plurality of internal speakers including at least a surround speaker behind the listener on the seat and a subwoofer, and has an opening for entry and exit of the listener. This structure prevents leakage and spread of high-volume music, and does not disturb its surroundings with noise, enabling the listener to enjoy optimum surround sound in a small space.

### BACKGROUND OF INVENTION

### Field of the Invention

The present invention relates to a novel music listening apparatus including a reclining seat and a sound system such as a surround system.

### Background Art

In watching DVDs at home with traditional systems, the sound, which comes from the speakers of a television or a stereo, can be unsatisfactory. However, stereophonic sound systems such as 5.1 and 7.1 channel surround systems have recently been developed to allow people at home to enjoy videos as if they are at a movie theater. Such a sound system includes multiple speakers, such as center, front, and surround speakers and a subwoofer surrounding a viewer at predetermined angles. The individual speakers output independent sounds at appropriate timing to achieve a stereophonic and realistic effect.

Most listeners or viewers sit on chairs or sofas when listening to music or watching DVDs. Various chairs with speakers inside or near the chair bodies have been developed for music listeners as described in, for example, Patent Literatures 1 to 6.

### CITATION LIST

### Patent Literature

Patent Literature 1: Japanese Unexamined Patent Application Publication No. 2014-400

Patent Literature 2: Japanese Unexamined Patent Application Publication No. 2004-121307

Patent Literature 3: Japanese Unexamined Patent Application Publication No. 2002-223890

Patent Literature 4: Japanese Unexamined Patent Application Publication No. 2002-152880

Patent Literature 5: Japanese Unexamined Patent Application Publication No. 10-285678

Patent Literature 6: Japanese Unexamined Patent Application Publication No. 7-23829

### SUMMARY OF INVENTION

### Technical Problem

However, high-performance sound systems such as surround systems, which provide powerful sound just like in movie theaters or concert halls, may not fit in small houses or home environments in Japan. Additionally, chairs with speakers inside or near the chair bodies cannot easily reproduce stereophonic high-quality sound.

One or more aspects of the present invention are directed to a novel music listening apparatus that allows people to enjoy sound and music comfortably without disturbing their surroundings.

### Solution to Problem

A music listening apparatus according to a first aspect of the present invention includes a seat for a listener to sit on, a sound-insulating housing body integral with the seat to surround the listener on the seat, and a leg supporting the housing body. The housing body includes a plurality of internal speakers including at least a surround speaker and a subwoofer behind the listener on the seat. The housing body has an opening for entry and exit of the listener.

In this structure, when the listener enters the housing body through the opening and sits on the seat, at least his or her head is within the sound-insulating housing body. The listener in this state listens to sound or music from the multiple internal speakers. Any increased sound volume will remain within the housing body without leaking or spreading to its surroundings. The listener can thus comfortably enjoy music or sound without disturbing others with noise. The apparatus including at least the surround speaker and the subwoofer also enable the listener to enjoy surround music with powerful heavy bass sound.

A music listening apparatus according to a second aspect of the present invention is the apparatus according to the first aspect in which the plurality of speakers include a pair of center speakers on two sides of the opening, and a front speaker in front of the listener on the seat. This structure enables the listener to enjoy more effective surround music.

A music listening apparatus according to a third aspect of the present invention is the apparatus according to the first aspect in which the plurality of speakers include a pair of center speakers located on an inner wall of the housing body on two sides of the opening, a pair of right and left front speakers located on the inner wall of the housing body in front of the listener on the seat, a pair of right and left surround speakers located on the inner wall of the housing body behind the listener on the seat, and subwoofers under and behind the listener on the seat. This structure enables the listener to enjoy realistic surround sound of low to high registers in a small space.

A music listening apparatus according to a fourth aspect of the present invention is the apparatus according to one of the first to third aspects in which the housing body is spherical or egg-shaped. This structure allows the speakers to have the optimum orientations and equal distances to the listener's head at the center of the housing body, producing an optimum sound effect. Additionally, the apparatus has a novel appearance that provides a soft impression and is expected to attract more customers or serve as an exhibition piece.

A music listening apparatus according to a fifth aspect of the present invention is the apparatus according to the fourth aspect in which the housing body is divided at the opening into right and left parts or upper and lower parts. The housing body that can be divided at the opening into right and left parts or upper and lower parts can be easily transported and stored.

A music listening apparatus according to a sixth aspect of the present invention is the apparatus according to the fifth aspect in which a portion at which the housing body is division is connectable to a spacer. This structure allows the volume of the internal space to be freely adjusted by adding or removing the spacer depending on, for example, the number of listeners.

A music listening apparatus according to a seventh aspect of the present invention is the apparatus according to one of the first to sixth aspects in which the seat includes a headrest to support a head of the listener, and the seat reclines with respect to the headrest. With this structure, the listener changing his or her posture by reclining can have his or her head positioned as substantially unchanged. The listener at any posture can thus continuously enjoy the optimum surround sound.

A music listening apparatus according to an eighth aspect of the present invention is the apparatus according to the seventh aspect in which the seat includes the headrest that is stationary, a backrest connected with the headrest, and a seating surface connected with the backrest. The backrest is raised and lowered with respect to the headrest. The seating surface is raised and lowered with respect to a connection between the seating surface and the backrest. This structure enables the listener to change the posture as intended, while having his or her head positioned as substantially unchanged.

A music listening apparatus according to a ninth aspect of the present invention is the apparatus according to the eighth aspect in which the seat further includes a footrest connected with the seating surface, and the footrest is positioned outside the opening. This structure enables the seated listener to settle into a more comfortable posture by placing the legs on the footrest. Further, the lower body or legs of the listener extend outside on the footrest outside the opening, allowing any person outside to easily see that someone is using the apparatus.

A music listening apparatus according to a tenth aspect of the present invention is the apparatus according to one of the first to ninth aspects in which the seat, the housing body, or the leg includes a speaker drive amplifier to drive the speakers. This structure uses fewer wires, and also costs less without any additional subwoofer amplifier.

### Advantageous Effects

In the above aspects of the present invention, when a listener enters the housing body through the opening and sits on the seat, at least his or her head is within the sound-insulating housing body. The listener in this state listens to sound or music from the multiple internal speakers. Any increased sound volume will remain within the housing body without leaking or spreading to its surroundings. The listener can thus comfortably enjoy music or sound without disturbing others with noise.

### BRIEF DESCRIPTION OF THE DRAWINGS

FIG. 1 is a perspective view of a music listening apparatus 100 according to an embodiment of the present invention.

FIG. 2 is a vertical sectional view of the music listening apparatus 100 shown in FIG. 1.

FIG. 3 is a block diagram of the music listening apparatus 100 according to the embodiment of the present invention.

FIG. 4 is a diagram describing the positional relationship of speakers.

FIG. 5 is a conceptual diagram showing the apparatus with a listener L on a reclining seat 20.

FIG. 6 is a conceptual diagram showing the apparatus with the reclining seat 20 moved to lean the listener L backward.

FIG. 7 is a perspective view of a music listening apparatus 100 according to another embodiment of the present invention.

FIG. 8 is a vertical sectional view of a music listening apparatus 100 according to another embodiment of the present invention.

FIG. 9 is a perspective view of a music listening apparatus 100 according to another embodiment of the present invention.

FIG. 10 is a side view of a music listening apparatus 100 according to another embodiment of the present invention.

### DETAILED DESCRIPTION

Embodiments of the present invention will now be described with reference to the accompanying drawings. FIG. 1 shows a music listening apparatus 100 according to one embodiment of the present invention. As shown in the figure, the music listening apparatus 100 mainly includes a sound-insulating housing 10 and a reclining seat 20 installed in the housing 10.

The housing 10 includes a spherical housing body 11 integral with a leg 12 that is truncated cone shaped. The housing body 11 is plastic or metallic. The housing body 11 is large enough for a person to easily enter. The housing body 11 has a diameter of, for example, about 1.2 to 1.5 m. The front of the housing body 11 has a circular opening 30 large enough for a listener (person) L to easily pass through. The circular opening 30 has a diameter of, for example, about 1.0 m. More specifically, the opening 30 may constitute about 20 to 40% of the surface area of the housing body 11 to allow easy entry into and exit from the housing body 11 as well as to provide a listener with a private room without a confined feeling. Also, the structure does not obstruct a view of, for example, an external screen through the opening 30.

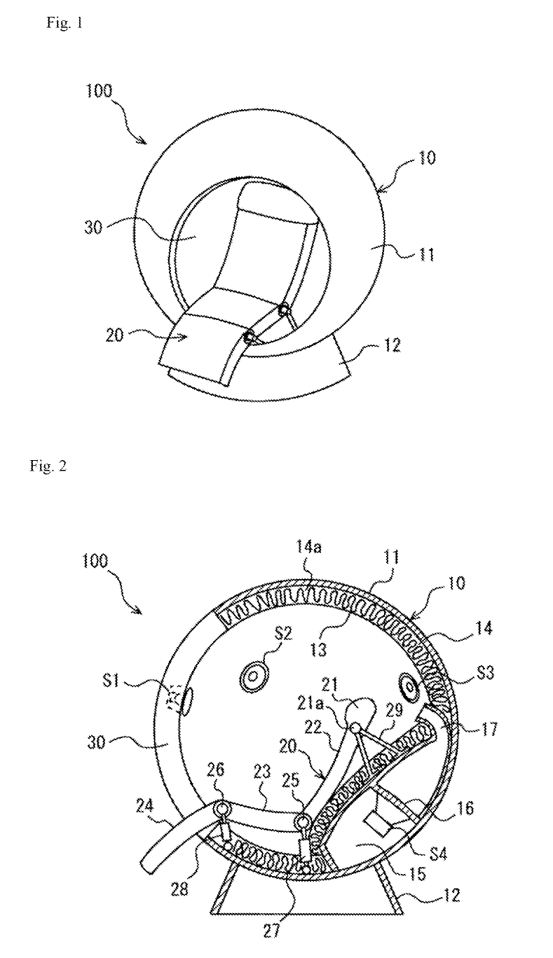

The reclining seat 20 allows the listener L to be seated comfortably. As shown in FIG. 2, the reclining seat 20 includes a headrest 21 at the substantial center of the housing body 11, a backrest 22 integral with the headrest 21, a seating surface 23 connected with the backrest 22, and a footrest 24 integral with the seating surface 23.

The headrest 21, which supports the head of the listener L, includes a support shaft 21a extending horizontally through the headrest 21. The support shaft 21a is pivotally supported at its two ends by support legs 29 fixed to the housing body 11. The backrest 22 integral with the headrest 21 is thus movable up and down about the support shaft 21a in the headrest 21. The seating surface 23, which is connected to the lower end of the backrest 22 with a connection shaft 25, is thus movable up and down about the connection shaft 25.

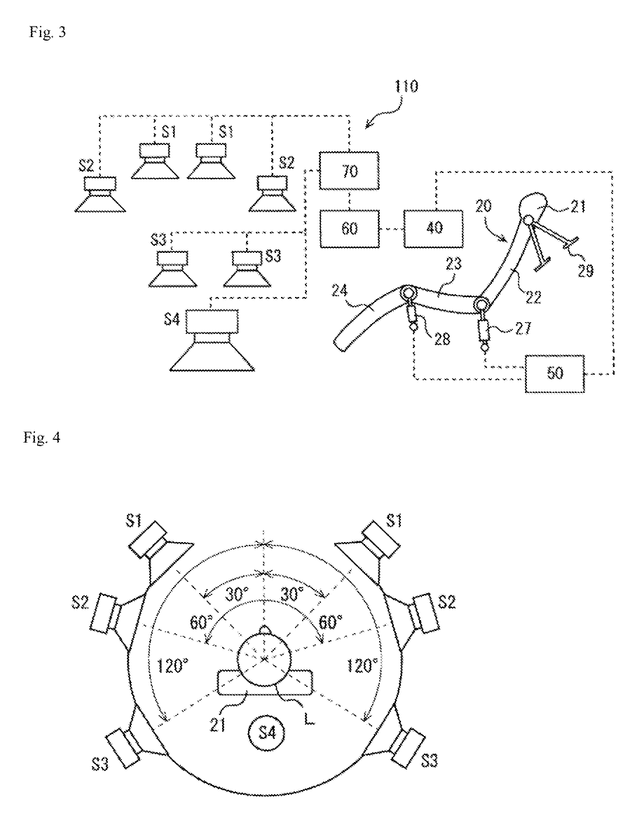

The connection shaft 25 connecting the seating surface 23 and the backrest 22 is supported by a pair of first lift cylinders 27 (one shown) at its two ends. Each first lift cylinder 27 has its upper end connected to the connection shaft 25 and its lower end connected to the housing body 11. The first lift cylinders 27 reciprocate upon receiving hydraulic pressure from an actuator 50 as shown in FIG. 3.

The seating surface 23 also has a support shaft 26 adjacent to the footrest 24. The support shaft 26 is supported by a pair of second lift cylinders 28 (one shown) at its two ends. Each second lift cylinder 28 has its upper end connected to the support shaft 26 and its lower end connected to the housing body 11. Like the first lift cylinders 27, the second lift cylinders 28 reciprocate upon receiving hydraulic pressure from the actuator 50 as shown in FIG. 3.

As shown in FIG. 2, the housing body 11 has a similarly spherical inner wall 13 with a clearance 14 of about 10 cm between them. The clearance 14 is filled with a soundproof material 14a, such as urethane sponge. The inner wall 13 incorporates a pair of center speakers S1, a pair of front speakers S2, a pair of surround speakers S3, and a subwoofer S4, which form a surround sound system 110 described later.

The housing body 11 also has a cavity 15 behind the backrest 22. The cavity 15 accommodates a partition 16, on which the subwoofer S4 is mounted. The cavity 15 has a communication hole 17, which communicates with the housing body 11. The communication hole 17 transmits heavy bass sound (air vibration) from the subwoofer S4 into the housing body 11.

The housing 10 includes the surround sound system 110 as shown in FIG. 3. The surround sound system 110 includes multiple speakers such as the pair of center speakers S1, the pair of front speakers S2, the pair of surround speakers S3, and the single subwoofer S4 as described above. The surround sound system 110 further includes a sound reproducer 60, an amplifier 70, and a controller (remote control) 40.

The sound reproducer 60 controlled by the controller 40 reproduces the sound source of a CD or a DVD to extract the surround sound data. The amplifier 70 distributes the sound data among the channels to generate surround sound sources that have slightly different volume levels and timings, and the individual speakers output their own sound. The controller 40 may be placed near the reclining seat 20 or directly held by the listener in his or her hand.

FIG. 4 shows the positional relationship of the speakers in the housing body 11. The pair of center speakers S1 is positioned at the right front and the left front of the headrest 21, on which the head of the listener L lies. More specifically, the center speakers S1 are arranged at angles of about 30 degrees clockwise and counterclockwise from the center of the opening 30 of the housing body 11 as shown in FIG. 1. The front speakers S2 are arranged at angles of about 60 degrees clockwise and counterclockwise from the center of the opening 30. Additionally, the surround speakers S3 are arranged at angles of about 120 degrees clockwise and counterclockwise from the center of the opening 30. The subwoofer S4 is arranged behind the headrest 21.

The amplifier 70 in the surround sound system 110 adjusts the sound volume and the timing to output sound from each speaker to achieve the optimum surround sound at the position of the headrest 21. For a system that reproduces the video of a DVD or other media together with sound, a large liquid crystal monitor or a projection screen to be installed in front of the opening 30. The listener L sitting on the reclining seat 20 watches the video on the monitor through the opening 30.

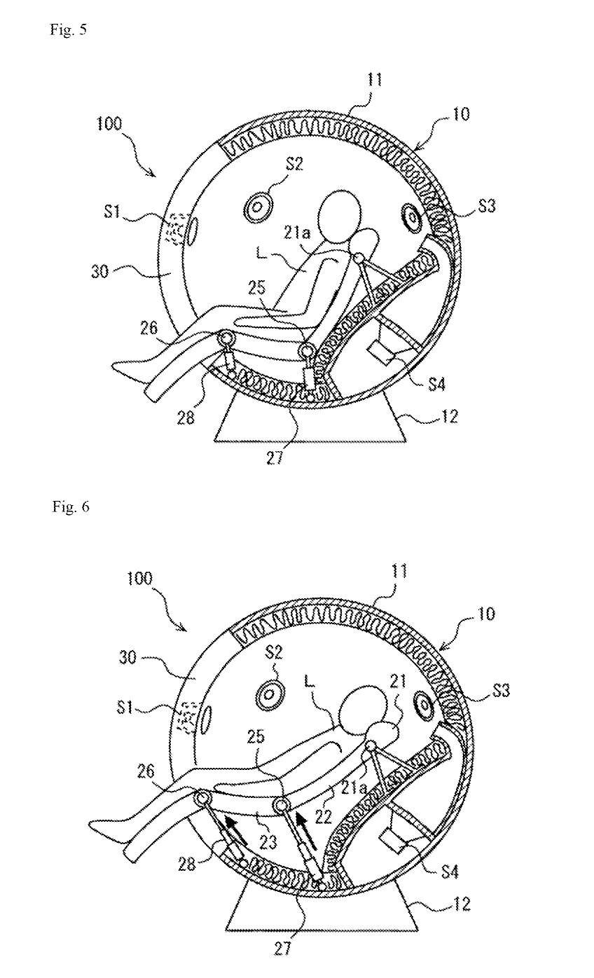

In the music listening apparatus 100 with this structure according to the embodiment of the present invention, the listener L sitting on the reclining seat 20 as shown in FIG. 5 has his or her head at the substantial center inside the housing 10, while listening to sound or music output from the multiple internal speakers. The housing 10, which is sound-insulating, prevents leakage and spread of high-volume sound from the speakers, and does not disturb its surrounding with noise. Further, the multiple speakers forming the surround sound system 110 are arranged inside the housing 10. This structure enables the listener L to enjoy high-quality surround sound in a small space. Additionally, with his or her upper body inside the housing 10, the listener L is prevented from being distracted by other view, and can concentrate on the sound or music.

The reclining seat 20 has the seating surface 23 adjacent to the opening 30. The listener L thus has his or her lower body or legs outside the housing 10 while the upper body is resting within the housing 10. The listener L can thus feel less confined and has easy entry into and exit from the housing 10. This structure allows a person inside the housing 10 to be easily seen from the outside. The apparatus can thus be used in a rental room or a public facility.

The reclining seat 20, for the listener L to sit on, reclines entirely with respect to the headrest 21. Any change in the posture of the listener L does not change the position of the head. The listener L can thus continuously enjoy the optimum surround sound. More specifically, as shown in FIG. 6, the first lift cylinders 27 are extended from a normal state (in FIG. 5) to cause the lower end of the backrest 22 to rotate the headrest 21 upward and to lift the seating surface 23 connected to the backrest 22.

The backrest 22 thus tilts with respect to the seating surface 23, lifting the lower back of the listener L into a more relaxed posture in which the listener L leans (or lies) back with his or her lower back stretched. The listener L can operate the controller 40 to freely extend the first lift cylinders 27 to an intended extension. During the operation, the position of the headrest 21 remains substantially unchanged from the original position, also maintaining the head position of the listener L substantially unchanged. Thus, the listener L has his or her head (ears) continuously maintained at the same position independently of any change in the posture of the listener L on the reclining seat 20, enabling the listener L to continuously enjoy the optimum surround sound with no change in the positional relationship between the head (ears) and each speaker.

Further, extending the second lift cylinders 28 in the same manner as extending the first lift cylinders 27 allows the listener L to have his or her lower body and legs horizontal as shown in FIG. 6, and his or her entire body substantially horizontal. The listener L can enjoy sound or music in a more relaxed posture. The listener L can retract the first lift cylinders 27 and the second lift cylinders 28 to return the reclining seat 20 to the original state, and can then easily exit the housing body 11.

In the present embodiment, the six speakers including the center speakers S1, the front speakers S2, the surround speakers S3, and the subwoofer S4 form a 5.1 channel surround sound system. However, a 7.1 or 9.1 channel surround sound system including more speakers can also achieve the same effect. The housing 10 may have any other nonspherical shape, such as an egg, a box, or a dome. The housing body 11 may include an additional monitor inside.

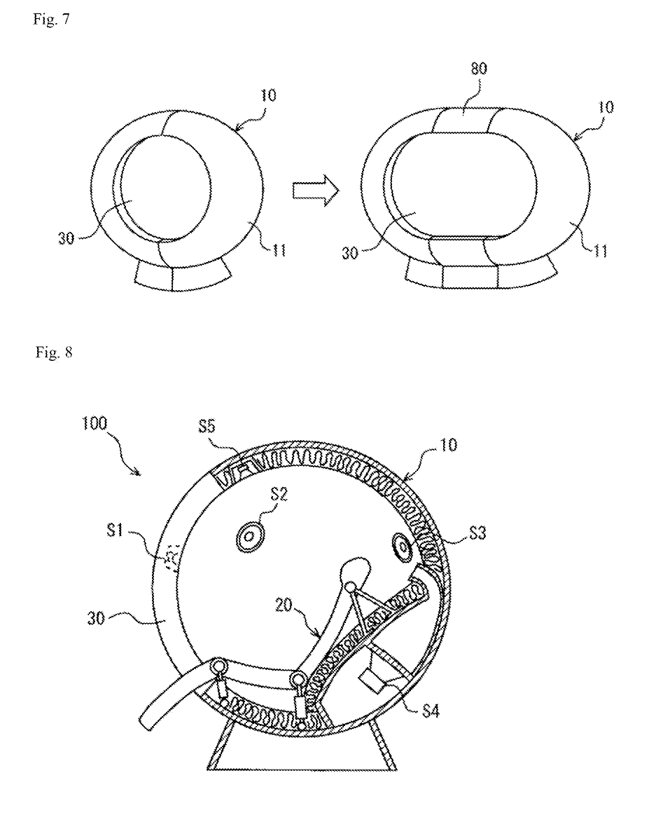

In some embodiments, the housing body 11 may be divided at the center of the opening 30 into right and left parts as shown in FIG. 7, and may include a spacer 80 installed between the parts. This structure widens the housing body 11 and the opening 30 horizontally, allowing a couple or two or more listeners to enter the housing body 11 together and enjoy the same sound or music. The structure may additionally include a fifth speaker installed on the ceiling of the housing body 11 as shown in FIG. 8 to produce sound with more realistic sound effect from overhead.

For cost savings, the reclining seat 20 may be replaced with a common stationary seat, or the surround sound system 110 may be replaced with a common stereo sound system.

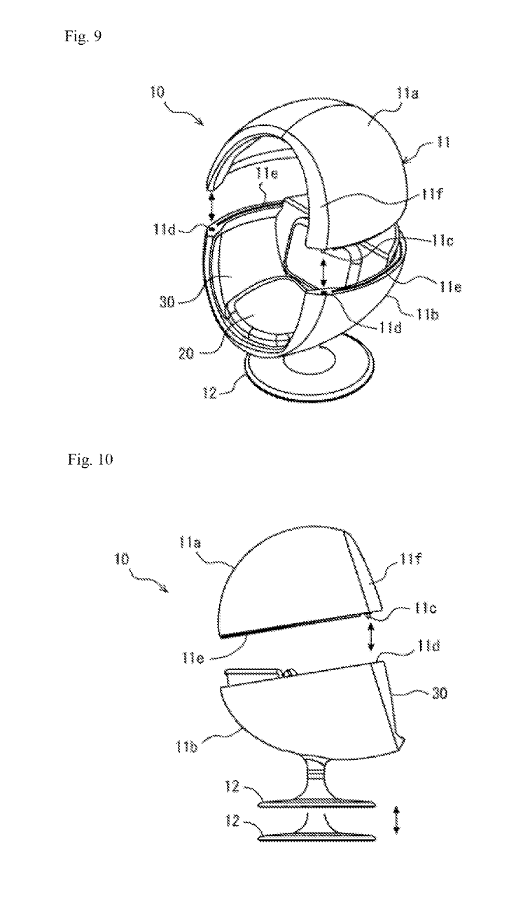

The housing body 11 may also be divided at its vertical middle into upper and lower parts as shown in FIGS. 9 and 10. This structure reduces the size of, or specifically the height of the housing body 11, which is a large part of the apparatus. This eases transportation and storage of the apparatus. For easy assembly, for example, an upper housing body 11a may have guide pins 11c near the opening 30, and a lower housing body 11b may have guide holes 11d near the opening 30. The apparatus with this structure can be easily and accurately assembled with the guide pins 11c placed into the guide holes 11d.

Additionally, a gasket lie may be used at the contact between the upper housing body 11a and the lower housing body 11b to prevent sound leakage. The opening 30 may also have an edge 11f bent toward the inside of the housing body 11, and the center speakers S1 or the front speakers S2 may be incorporated in the edge 11f to transmit sound to the listener L more effectively. As shown in FIG. 10, the apparatus may have a single reverse T-shaped leg 12, which may be screwed up and down. The screwable leg 12 can easily adjust the height of the housing body 11 depending on, for example, the body size of the listener L.

The housing body 11, the leg 12, or the reclining seat 20 may incorporate an amplifier that drives each speaker. Most current speakers are passive speakers, which may be connected to a commercial AV amplifier with multiple lines to drive the speakers. However, the housing body 11 may incorporate a subwoofer amplifier, or the housing body 11 may have a built-in amplifier for every speaker, to receive music signals via a wireless LAN. This structure uses fewer wires, and also costs less without any additional subwoofer amplifier.

### REFERENCE SIGNS LIST

100 music listening apparatus
110 surround sound system
10 housing
11 housing body
11a upper housing body
11b lower housing body
12 leg
14a sound insulator
20 reclining seat
21 headrest
22 backrest
23 seating surface
24 footrest
30 opening
40 controller
50 actuator
60 sound reproducer
70 amplifier
80 spacer
S1 center speaker
S2 front speaker
S3 surround speaker
S4 subwoofer
S5 overhead speaker
L listener

1. A music listening apparatus, comprising:
a seat for a listener to sit on;
a sound-insulating housing body integral with the seat to surround the listener on the seat; and
a leg supporting the housing body,
wherein the housing body includes a plurality of internal speakers including at least a surround speaker and a subwoofer behind the listener on the seat, and the housing body has an opening for entry and exit of the listener.

2. The music listening apparatus according to claim 1, wherein
the speakers include a pair of center speakers on two sides of the opening, and a front speaker in front of the listener on the seat.

3. The music listening apparatus according to claim 1, wherein
the plurality of speakers include a pair of center speakers located on an inner wall of the housing body on two sides of the opening, a pair of right and left front speakers located on the inner wall of the housing body in front of the listener on the seat, a pair of right and left surround speakers located on the inner wall of the housing body behind the listener on the seat, and subwoofers under and behind the listener on the seat.

4. The music listening apparatus according to claim 1, wherein
the housing body is spherical or egg-shaped.

5. The music listening apparatus according to claim 4, wherein
the housing body is divided at the opening into right and left parts or upper and lower parts.

6. The music listening apparatus according to claim 5, wherein
a portion at which the housing body is divided is connectable to a spacer.

7. The music listening apparatus according to claim 1, wherein
the seat includes a headrest to support a head of the listener, and the seat is configured to recline with respect to the headrest.

8. The music listening apparatus according to claim 7, wherein
the seat includes the headrest that is stationary, a backrest connected with the headrest, and a seating surface connected with the backrest, and
the backrest is configured to move up and down with respect to the headrest, and the seating surface is configured to move up and down with respect to a connection between the seating surface and the backrest.

9. The music listening apparatus according to claim 8, wherein
the seat further includes a footrest connected with the seating surface, and the footrest is positioned outside the opening.

10. The music listening apparatus according to claim 1, wherein
the seat, the housing body, or the leg includes a speaker drive amplifier to drive the speakers.
